(19) United States
(12) Patent Application Publication
(10) Pub. No.: US 2021/0142234 A1
(43) Pub. Date: May 13, 2021

(54) TRANSFORMING PARALLEL PROCESS MODELS INTO STATECHARTS

(71) Applicant: INTERNATIONAL BUSINESS MACHINES CORPORATION, Armonk, NY (US)

(72) Inventors: Hiroaki Nakamura, Yokohama-shi (JP); Kohtaroh Miyamoto, Tokyo (JP); Michiharu Kudo, Kanagawa-ken (JP)

(21) Appl. No.: 16/677,381

(22) Filed: Nov. 7, 2019

(51) Int. Cl. G06Q 10/06; G06Q 10/08; G06F 16/901; G06F 16/906

(52) U.S. Cl. CPC G06Q 10/067; G06F 16/906; G06F 16/9027; G06Q 10/087

(57) ABSTRACT

A computer-implemented method is provided for automatically transforming a Business Process Model (BPM) into a hierarchical statechart. The BPM has parallel paths with at least one FORK node and at least one JOIN node. The method includes, responsive to identifying each of the at least one FORK node in the BPM in a node analysis: (i) generating a FORK edge sub-statechart having an initial state and a working state for each of edges from the at least one FORK node, and attaching the FORK edge sub-statechart to a hierarchical state for the at least one FORK node; and (ii) generating a synchronizer sub-statechart corresponding to each JOIN node going through the FORK node to receive a synchronization event from each FORK edge sub-statechart, and attaching the synchronizer sub-statechart to the hierarchical state for the at least one FORK node to form an intermediate version of the hierarchical statechart.

### BACKGROUND

The present invention generally relates to information processing, and more particularly to transforming parallel process models into statecharts.

Transformation from business process models into state charts contributes to streamlining the development of distributed applications including blockchain-based distributed applications. However, parallel business process models are not well captured by statecharts. One reason is because business process models allow any combination of parallel paths, while in statecharts, parallel paths must be hierarchically structured as distinct sub-statecharts. Thus, there is a need for a method to transform parallel process models into statecharts.

### SUMMARY

According to an aspect of the present invention, a computer-implemented method is provided for automatically transforming a Business Process Model (BPM) into a hierarchical statechart. The BPM has parallel paths with at least one FORK node and at least one JOIN node. The method includes, responsive to identifying each of the at least one FORK node in the BPM in a node analysis: (i) generating a FORK edge sub-statechart having an initial state and a working state for each of edges from the at least one FORK node, and attaching the FORK edge sub-statechart to a hierarchical state for the at least one FORK node; and (ii) generating a synchronizer sub-statechart corresponding to each JOIN node going through the FORK node to receive a synchronization event from each FORK edge sub-statechart, and attaching the synchronizer sub-statechart to the hierarchical state for the at least one FORK node to form an intermediate version of the hierarchical statechart.

According to another aspect of the present invention, a computer program product is provided for automatically transforming a Business Process Model (BPM) into a hierarchical statechart. The BPM has parallel paths with at least one FORK node and at least one JOIN node. The computer program product includes a non-transitory computer readable storage medium having program instructions embodied therewith. The program instructions are executable by a computer to cause the computer to perform a method. The method includes responsive to identifying each of the at least one FORK node in the BPM in a node analysis: (i) generating a FORK edge sub-statechart having an initial state and a working state for each of edges from the at least one FORK node, and attaching the FORK edge sub-statechart to a hierarchical state for the at least one FORK node; and (ii) generating a synchronizer sub-statechart corresponding to each JOIN node going through the FORK node to receive a synchronization event from each FORK edge sub-statechart, and attaching the synchronizer sub-statechart to the hierarchical state for the at least one FORK node to form an intermediate version of the hierarchical statechart.

According to yet another aspect of the present invention, a computer processing system is provided for automatically transforming a Business Process Model (BPM) into a hierarchical statechart. The BPM has parallel paths with at least one FORK node and at least one JOIN node. The system includes a memory device including program code stored thereon. The system further includes a hardware processor, operatively coupled to the memory device, and configured to run the program code stored on the memory device to, responsive to identifying each of the at least one FORK node in the BPM in a node analysis: (i) generate a FORK edge sub-statechart having an initial state and a working state for each of edges from the at least one FORK node, and attach the FORK edge sub-statechart to a hierarchical state for the at least one FORK node; and (ii) generate a synchronizer sub-statechart corresponding to each JOIN node going through the FORK node to receive a synchronization event from each FORK edge sub-statechart, and attach the synchronizer sub-statechart to the hierarchical state for the at least one FORK node to form an intermediate version of the hierarchical statechart.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary processing system, in accordance with an embodiment of the present invention;

FIG. 2 is a block diagram showing an exemplary Business Process Model (BPM) to which the present invention can be applied, in accordance with an embodiment of the present invention;

FIG. 3 is a diagram showing an exemplary output hierarchical statechart transformed from BPM 200, in accordance with an embodiment of the present invention.

FIGS. 4-5 are flow diagrams showing an exemplary method for transforming a Business Process Model (BPM) into a hierarchical statechart, in accordance with an embodiment of the present invention;

FIG. 6-7 are diagrams showing exemplary pseudocode for a main procedure for transforming a BPM into a hierarchical statechart, in accordance with an embodiment of the present invention;

FIG. 8 is a diagram showing exemplary pseudocode for a sub-procedure of creating an event, in accordance with an embodiment of the present invention;

FIG. 9 is a diagram showing exemplary pseudocode for a sub-procedure of attaching a synchronizer, in accordance with an embodiment of the present invention;

FIG. 10 is a diagram showing exemplary pseudocode for a sub-procedure of attaching a sub-statechart, in accordance with an embodiment of the present invention;

FIG. 11 is a diagram showing an exemplary structured BPM to which the present invention can be applied, in accordance with an embodiment of the present invention;

FIG. 12 is a diagram showing an exemplary output hierarchical statechart transformed from structured BPM 1100, in accordance with an embodiment of the present invention;

FIG. 13 is a diagram showing an exemplary unstructured BPM to which the present invention can be applied, in accordance with an embodiment of the present invention;

FIG. 14 is a diagram showing an exemplary output hierarchical statechart transformed from unstructured BPM 1300, in accordance with an embodiment of the present invention;

FIGS. 15-16 are flow diagrams showing an exemplary method for transforming a BPM into a hierarchical statechart, in accordance with an embodiment of the present invention.

FIG. 17 is a block diagram showing an illustrative cloud computing environment having one or more cloud computing nodes with which local computing devices used by cloud consumers communicate, in accordance with an embodiment of the present invention; and

FIG. 18 is a block diagram showing a set of functional abstraction layers provided by a cloud computing environment, in accordance with an embodiment of the present invention.

### DETAILED DESCRIPTION

Embodiments of the present invention are directed to transforming parallel process models into statecharts.

In an embodiment, the present invention can provide a transformation method that can transformed parallel business process models, both structured and unstructured ones, into statecharts.

In an embodiment, synchronization is realized only by events sent and received by statecharts. No guard conditions or other means are used.

In an embodiment, communications between statecharts are synchronous so that a blockchain can track the last snapshot of the entire system. Queues or other asynchronous communication mechanisms are not used.

In an embodiment, a business process model to which the present invention is applied includes parallel paths with a FORK node and a JOIN node. A FORK node is a node that divides the flow into two paths performed in parallel. A JOIN node is a node that combines two nodes.

In an embodiment, a FORK element is represented as a hierarchical state that has two sub-statecharts corresponding to its two outgoing flows.

In an embodiment, a JOIN element is represented as a statechart that receives two events for synchronizing the paths (synchronizer) and two transitions that send events to the synchronizer.

A flat statechart is represented as a directed graph, where states are nodes and state transitions are edges of the graph. A transition can have a label to specify a receiving event to trigger the transition. A transition can perform actions, including sending events.

A hierarchical statechart, as used by embodiments of the present invention, is an extension of flat statechart in that a state can have sub-statecharts. When multiple sub-statecharts are attached to a single state, they can be executed in parallel. The present invention advantageously transforms a BPM into a hierarchical statechart. A hierarchical statechart can be considered an enhanced state machine. When a state is entered, its sub state machine starts and therefore, a substate is entered. When a state is exited, its sub state machine is exited too, i.e. any substates also exit. Hence, a hierarchical statechart is essentially a state machine that allows any state to include more machines, in a hierarchical fashion.

FIG. 1 is a block diagram showing an exemplary processing system 100, in accordance with an embodiment of the present invention. The processing system 100 includes a set of processing units (e.g., CPUs) 101, a set of GPUs 102, a set of memory devices 103, a set of communication devices 104, and set of peripherals 105. The CPUs 101 can be single or multi-core CPUs. The GPUs 102 can be single or multi-core GPUs. The one or more memory devices 103 can include caches, RAMs, ROMs, and other memories (flash, optical, magnetic, etc.). The communication devices 104 can include wireless and/or wired communication devices (e.g., network (e.g., WIFI, etc.) adapters, etc.). The peripherals 105 can include a display device, a user input device, a printer, an imaging device, and so forth. Elements of processing system 100 are connected by one or more buses or networks (collectively denoted by the figure reference numeral 110).

In an embodiment, memory devices 103 can store specially programmed software modules to transform the computer processing system into a special purpose computer configured to implement various aspects of the present invention. For example, in an embodiment, memory devices 103 include a BPM to hierarchical statechart transformer 103A and a code generator 103B. In an embodiment, the code generator is used to generate a computer program modeling a BPM based on the hierarchical statechart obtained by transforming the BPM. In an embodiment, special purpose hardware (e.g., Application Specific Integrated Circuits, Field Programmable Gate Arrays (FPGAs), and so forth) can be used to implement various aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used (e.g., see FIGS. 17-18). These and other variations of the processing system 100 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 100.

FIG. 2 is a block diagram showing an exemplary Business Process Model (BPM) 200 to which the present invention can be applied, in accordance with an embodiment of the present invention.

The BMP 200 is represented as a directed graph with one start node/event 201 and one end node/event 291. The BPM 200 further includes at least one FORK node 210, at least one JOIN node 220, and flow edges 230 connecting two nodes. The start node/event 201 triggers the process. The end node/event 291 represents the result of the process. A FORK node 210 divides a flow into two paths performed in parallel. A JOIN node 220 combines two parallel flows into one flow. A flow edge 230 connects two nodes.

FIG. 3 is a diagram showing an exemplary output hierarchical statechart 300 transformed from BPM 200, in accordance with an embodiment of the present invention.

In the statechart 300, the following applies:

j₂ denotes the event to be sent from the first FORK edge sub-statechart to the synchronizer;

j_{2′} denotes the event to be sent from the second FORK edge sub-statechart to the synchronizer;

/j₂ denotes the action to send the event j₂ from the first FORK edge sub-statechart;

/j_{2′} denotes the action to send the event j_{2′} from the second FORK edge sub-statechart;

The solid arrows represent node-to-node transitions, while the dashed lines represent synchronizations realized by sending and receiving same events between portions of the output hierarchical statechart 300.

FIGS. 4-5 are flow diagrams showing an exemplary method 500 for transforming a Business Process Model (BPM) into a hierarchical statechart, in accordance with an embodiment of the present invention.

At block 405, perform a node analysis by analyzing each node of the BPM to identify the at least one FORK node and the at least one JOIN node.

At block 410, responsive to identifying each of the at least one FORK node in the BPM in a node analysis:

(i) prepare a hierarchical state for the at least one FORK node;

(ii) generate a FORK edge sub-statechart having an initial state and a working state, and for each of edges from the at least one FORK node, attaching the FORK edge sub-statechart to the hierarchical state for the at least one FORK node, and

(iii) generate a synchronizer sub-statechart corresponding to each JOIN node going through the FORK node to receive a synchronization event from each FORK edge sub-statechart, and attaching the synchronizer sub-statechart to the hierarchical state for the at least one FORK node. The phrase “JOIN node going through the FORK node” means every path to the JOIN node goes through the FORK node.

At block 415, responsive to identifying each of the at least one JOIN node in the BPM in the node analysis:

(i) generate a transition from the working state of the FORK edge sub-statechart to send the synchronization event to the synchronizer sub-statechart;

(ii) generate a second working state;

(iii) generate a transition from the hierarchical state for the FORK node to the second working state responsive to a number of transitions to send synchronization events and a number of transitions to receive the synchronization events being equal; and

(iv) generate a transition from the synchronizer sub-statechart for the FORK node to the second working state responsive to the numbers of transitions being unequal.

At block 420, output the hierarchical statechart.

At block 425, perform an action responsive to a state of the hierarchical state chart. For example, (1) when the first FORK edge sub-statechart transitions to the final state, the event j₂ is sent to the synchronizer sub-statechart, but the synchronizer is still in the state waiting for the other event j_{2′} to receive. (2) When the second FORK edge sub-statechart transitions to the final state, the event j_{2′} is sent to the synchronizer sub-statechart, and then the synchronizer transitions to its final state, which will cause the entire statechart to transition to its final state. For example, in an embodiment, a code generator is used to generate a computer program modeling the BPM, based on the hierarchical statechart obtained by transforming the BPM. Studies have shown that code generated from a statechart has less bugs than code generated from other basis.

FIGS. 6-7 are diagrams showing exemplary pseudocode for a main procedure 500 for transforming a BPM into a hierarchical statechart, in accordance with an embodiment of the present invention.

To that end, the following definitions apply:

Input: Process Model P=<O, o₀, F>;

O is a set of flow objects, including Start Event, End Event, Fork Node, and Join Node;

o₀∈O is the Start Event;

F⊆O×O is the flow relation;

Output: Statechart SC=<S, s₀, T, Fin>;

S is a set of states;

s₀∈S is the initial state; and

T⊆S×S×E×E is the transition relation (s, s′, e, a) from one state to s to another state s′ which occurs when the event e is received and sends an event a as a result of the action associate with the transition. When the transition has no sending or receiving event, we denote it as (s, s′).

Fin is the set of the final states.

FIG. 8 is a diagram showing exemplary pseudocode for a sub-procedure 800 of creating an event, in accordance with an embodiment of the present invention.

The sub-procedure 800 takes a process object o and a number c, and outputs an event e therefrom.

FIG. 9 is a diagram showing exemplary pseudocode for a sub-procedure 900 of attaching a synchronizer, in accordance with an embodiment of the present invention.

The sub-procedure 900 takes a state s and a join node j as input, and outputs the state s enhanced with the attached synchronizer sub-statechart.

FIG. 10 is a diagram showing exemplary pseudocode for a sub-procedure 1000 of attaching a sub-statechart, in accordance with an embodiment of the present invention.

The sub-procedure 1000 takes a parent state s as input, and outputs a working state s₁′.

An exemplary structured BPM and an exemplary unstructured BPM will now be described. As used herein, the term “structured BPM” refers to business process models which can be decomposed into a set of sub business process models each of which has only one incoming edge and one outgoing edge. As used herein, the term “unstructured BPM” refers to business process models which cannot be decomposed into such sub business process models.

FIG. 11 is a diagram showing an exemplary structured BPM 1100 to which the present invention can be applied, in accordance with an embodiment of the present invention.

The structured BPM 1100 includes a start event/node 1101, an AND FORK 1111, an AND FORK 1112, an AND JOIN 1121, an AND JOIN 1122, flow edges 1130, and an end event/node 1191.

AND JOIN 1121 is immediately dominated by AND FORK 1112. As a definition, D dominates N if every path from the entry to N must go through D. As another definition, D immediately dominates N if D does not dominate any other dominator of N.

AND JOIN 1122 is immediately dominated by AND FORK 1111.

FIG. 12 is a diagram showing an exemplary output hierarchical statechart 1200 transformed from structured BPM 1100, in accordance with an embodiment of the present invention.

The synchronizer 1210 becomes ready at the same time the corresponding FORK paths start, and so it can receive events from the FORK paths anytime, which means communications are always synchronous. When the second FORK edge sub-statechart transitions, the synchronizer 1121 becomes ready and it can receive events from the FORK 1112 paths.

FIG. 13 is a diagram showing an exemplary unstructured BPM 1300 to which the present invention can be applied, in accordance with an embodiment of the present invention.

The unstructured BPM 1300 includes a start event/node 1301, an AND FORK 1311, an AND FORK 1312, an AND JOIN 1321, and an AND JOIN 1322.

AND JOIN 1321 is immediately dominated by AND FORK 1311.

AND JOIN 1322 is immediately dominated by AND FORM 1311.

FIG. 14 is a diagram showing an exemplary output hierarchical statechart 1400 transformed from unstructured BPM 1300, in accordance with an embodiment of the present invention.

The synchronizer becomes ready at the same time the corresponding FORK paths start, and so it can receive events from the FORK paths anytime, which means communications are always synchronous. Unlike the hierarchical statechart 1200, two synchronizers 1321 and 1322 become ready before any FORK edge sub-statechart transition because the event j₄ may be sent before j₃ and j_{3′} and it must be received by a synchronizer sub-statechart.

FIGS. 15-16 are flow diagrams showing an exemplary method 1500 for transforming a BPM into a hierarchical statechart, in accordance with an embodiment of the present invention.

At block 1505, traverse each node of the business process model in a direction associated with the edges of the business process model as follows in the following blocks.

At block 1510, identify a target node as being a FORK node.

At block 1515, responsive to the target node being a FORK node that is visited for the first time, (i) create a hierarchical state for the FORK node, and (ii) search for the JOIN nodes such that every path to each JOIN node goes through the FORK node. For each JOIN element found, create a synchronizer sub-statechart which receives synchronization events from other sub-statecharts and attach the synchronizer to the hierarchical state for the Fork node.

At block 1520, responsive to the target node being a FORK node that has been visited already, create a sub-statechart consisting of an initial state and a working state, and attach it to the hierarchical state for the Fork node.

At block 1525, identify a target node as being a JOIN node.

At block 1530, responsive to the target node being a JOIN node, create a transition from the working state. Attach to the transition an action to send a synchronization event.

At block 1535, responsive to the target node being a JOIN node that will be visited again, move backwards on the traverse path.

At block 1540, responsive to the target node being a join node that will not be visited again, count the number of transitions which sends events and that which receive events in the hierarchical state of the Fork node which the synchronizer of the Join node belongs to.

At 1545, responsive to the numbers being equal, create a working state and a transition from the hierarchical state for the Fork element to the working state.

At block 1550, responsive to the numbers being unequal, create a working state and a transition from the synchronizer to the working state.

At block 1555, selectively perform an action responsive to the numbers being equal or unequal. In an embodiment, the action can involve the state transitions of all sub-statecharts which synchronously occur by sending and receiving events regardless of whether the input business process models are structured or unstructured.

In an embodiment, the present invention can provide a cloud-based service that performs transformations of BPMs into corresponding statecharts.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 17, illustrative cloud computing environment 1750 is depicted. As shown, cloud computing environment 1750 includes one or more cloud computing nodes 1710 with which local computing devices used by cloud consumers, such as, for example, personal digital assistant (PDA) or cellular telephone 1754A, desktop computer 1754B, laptop computer 1754C, and/or automobile computer system 1754N may communicate. Nodes 1710 may communicate with one another. They may be grouped (not shown) physically or virtually, in one or more networks, such as Private, Community, Public, or Hybrid clouds as described hereinabove, or a combination thereof. This allows cloud computing environment 1750 to offer infrastructure, platforms and/or software as services for which a cloud consumer does not need to maintain resources on a local computing device. It is understood that the types of computing devices 1754A-N shown in FIG. 17 are intended to be illustrative only and that computing nodes 1710 and cloud computing environment 1750 can communicate with any type of computerized device over any type of network and/or network addressable connection (e.g., using a web browser).

Referring now to FIG. 18, a set of functional abstraction layers provided by cloud computing environment 1750 (FIG. 17) is shown. It should be understood in advance that the components, layers, and functions shown in FIG. 18 are intended to be illustrative only and embodiments of the invention are not limited thereto. As depicted, the following layers and corresponding functions are provided:

Hardware and software layer 1860 includes hardware and software components. Examples of hardware components include: mainframes 1861; RISC (Reduced Instruction Set Computer) architecture based servers 1862; servers 1863; blade servers 1864; storage devices 1865; and networks and networking components 1866. In some embodiments, software components include network application server software 1867 and database software 1868.

Virtualization layer 1870 provides an abstraction layer from which the following examples of virtual entities may be provided: virtual servers 1871; virtual storage 1872; virtual networks 1873, including virtual private networks; virtual applications and operating systems 1874; and virtual clients 1875.

In one example, management layer 1880 may provide the functions described below. Resource provisioning 1881 provides dynamic procurement of computing resources and other resources that are utilized to perform tasks within the cloud computing environment. Metering and Pricing 1882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1883 provides access to the cloud computing environment for consumers and system administrators. Service level management 1884 provides cloud computing resource allocation and management such that required service levels are met. Service Level Agreement (SLA) planning and fulfillment 1885 provide pre-arrangement for, and procurement of, cloud computing resources for which a future requirement is anticipated in accordance with an SLA.

Workloads layer 1890 provides examples of functionality for which the cloud computing environment may be utilized. Examples of workloads and functions which may be provided from this layer include: mapping and navigation 1891; software development and lifecycle management 1892; virtual classroom education delivery 1893; data analytics processing 1894; transaction processing 1895; and transforming Business Process Models (BPMs) into statecharts 1896.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for automatically transforming a Business Process Model (BPM) into a hierarchical statechart, the BPM having parallel paths with at least one FORK node and at least one JOIN node, the method comprising;
responsive to identifying each of the at least one FORK node in the BPM in a node analysis:
generating a FORK edge sub-statechart having an initial state and a working state for each of edges from the at least one FORK node, and attaching the FORK edge sub-statechart to a hierarchical state for the at least one FORK node; and
generating a synchronizer sub-statechart corresponding to each JOIN node going through the FORK node to receive a synchronization event from each FORK edge sub-statechart, and attaching the synchronizer sub-statechart to the hierarchical state for the at least one FORK node to form an intermediate version of the hierarchical statechart.

2. The computer-implemented method of claim 1, further comprising:
responsive to identifying each of the at least one JOIN node in the BPM in the node analysis:
generating a transition from the working state of the FORK edge sub-statechart to send the synchronization event to the synchronizer sub-statechart;
generating a second working state;
generating a transition from the hierarchical state for the at least one FORK node to the second working state to form a final version of the hierarchical statechart, responsive to a number of transitions to send synchronization events and a number of transitions to receive the synchronization events being equal; and
generating a transition from the synchronizer sub-statechart for the at least one FORK node to the second working state to form the final version of the hierarchical statechart, responsive to the numbers of transitions being unequal.

3. The computer-implemented method of claim 2, wherein the node analysis comprises analyzing each node of the BPM to identify the at least one FORK node and the at least one JOIN node.

4. The computer-implemented method of claim 2, wherein the BPM relates to inventory control, and the method further comprises automatically restocking an item having a current inventory below a threshold amount, responsive to a state in the final version of the hierarchical statechart relating to the current inventory.

5. The computer-implemented method of claim 2, wherein the node analysis, responsive to a non-first visit to the at least one JOIN node, the method further comprises moving backward on a traversal path used in the node analysis.

6. The computer-implemented method of claim 2, wherein the second working state represents a current state of the BPM relative to the statechart.

7. The computer-implemented method of claim 2, wherein the transition from the working state of the FORK edge sub-statechart and the transition from the hierarchical state for the FORK node are unguarded.

8. The computer-implemented method of claim 2, further comprising automatically generating, by a code generator, a computer program modeling the BPM using the final version of the hierarchical statechart.

9. The computer-implemented method of claim 1, wherein, responsive to identifying each of the at least one FORK node in the BPM in the node analysis, preparing the hierarchical state for the at least one FORK node by generating sub-statecharts for FORK edges and one synchronizer sub-statechart.

10. The computer-implemented method of claim 1, wherein the BPM is a structured BPM.

11. The computer-implemented method of claim 1, wherein the BPM is an unstructured BPM.

12. The computer-implemented method of claim 1, responsive to identifying each of the at least one FORK node in the BPM in the node analysis, the method further comprises:
assigning an initial state of one of two parallel paths created by the FORK node to a current state responsive to a first visit to the FORK node; and
assigning the initial state of another one of the two parallel paths created by the FORK node to the current state responsive to a subsequent visit to the FORK node.

13. A computer program product for automatically transforming a Business Process Model (BPM) into a hierarchical statechart, the BPM having parallel paths with at least one FORK node and at least one JOIN node, the computer program product comprising a non-transitory computer readable storage medium having program instructions embodied therewith, the program instructions executable by a computer to cause the computer to perform a method comprising:
responsive to identifying each of the at least one FORK node in the BPM in a node analysis:
generating a FORK edge sub-statechart having an initial state and a working state for each of edges from the at least one FORK node, and attaching the FORK edge sub-statechart to a hierarchical state for the at least one FORK node; and
generating a synchronizer sub-statechart corresponding to each JOIN node going through the FORK node to receive a synchronization event from each FORK edge sub-statechart, and attaching the synchronizer sub-statechart to the hierarchical state for the at least one FORK node to form an intermediate version of the hierarchical statechart.

14. The computer-implemented method of claim 13, further comprising:
responsive to identifying each of the at least one JOIN node in the BPM in the node analysis:
generating a transition from the working state of the FORK edge sub-statechart to send the synchronization event to the synchronizer sub-statechart;
generating a second working state;
generating a transition from the hierarchical state for the at least one FORK node to the second working state to form a final version of the hierarchical statechart, responsive to a number of transitions to send synchronization events and a number of transitions to receive the synchronization events being equal; and
generating a transition from the synchronizer sub-statechart for the at least one FORK node to the second working state to form the final version of the hierarchical statechart, responsive to the numbers of transitions being unequal.

15. The computer-implemented method of claim 14, wherein the node analysis comprises analyzing each node of the BPM to identify the at least one FORK node and the at least one JOIN node.

16. The computer-implemented method of claim 14, wherein the BPM relates to inventory control, and the method further comprises automatically restocking an item having a current inventory below a threshold amount, responsive to a state in the final version of the hierarchical statechart relating to the current inventory.

17. The computer-implemented method of claim 14, wherein the node analysis, responsive to a non-first visit to the at least one JOIN node, the method further comprises moving backward on a traversal path used in the node analysis.

18. The computer-implemented method of claim 14, wherein the second working state represents a current state of the BPM relative to the statechart.

19. The computer-implemented method of claim 14, wherein the transition from the working state of the FORK edge sub-statechart and the transition from the hierarchical state for the FORK node are unguarded.

20. The computer-implemented method of claim 14, further comprising automatically generating, by a code generator, a computer program modeling the BPM using the final version of the hierarchical statechart.

21. The computer-implemented method of claim 13, wherein, responsive to identifying each of the at least one FORK node in the BPM in the node analysis, preparing the hierarchical state for the at least one FORK node by generating sub-statecharts for FORK edges and one synchronizer sub-statechart.

22. The computer-implemented method of claim 13, wherein the BPM is a structured BPM.

23. The computer-implemented method of claim 13, wherein the BPM is an unstructured BPM.

24. The computer-implemented method of claim 13, responsive to identifying each of the at least one FORK node in the BPM in the node analysis, the method further comprises:
assigning an initial state of one of two parallel paths created by the FORK node to a current state responsive to a first visit to the FORK node; and
assigning the initial state of another one of the two parallel paths created by the FORK node to the current state responsive to a subsequent visit to the FORK node.

25. A computer processing system for automatically transforming a Business Process Model (BPM) into a hierarchical statechart, the BPM having parallel paths with at least one FORK node and at least one JOIN node, the system comprising:
a memory device including program code stored thereon;
a hardware processor, operatively coupled to the memory device, and configured to run the program code stored on the memory device to,
responsive to identifying each of the at least one FORK node in the BPM in a node analysis:
generate a FORK edge sub-statechart having an initial state and a working state for each of edges from the at least one FORK node, and attach the FORK edge sub-statechart to a hierarchical state for the at least one FORK node; and
generate a synchronizer sub-statechart corresponding to each JOIN node going through the FORK node to receive a synchronization event from each FORK edge sub-statechart, and attach the synchronizer sub-statechart to the hierarchical state for the at least one FORK node to form an intermediate version of the hierarchical statechart.
